(19) United States
(12) Patent Application Publication
(10) Pub. No.: US 2014/0084167 A1
(43) Pub. Date: Mar. 27, 2014

(54) SCINTILLATOR AND RADIATION DETECTOR

(71) Applicants: Yoshihiro Ohashi, Tokyo (JP); Nobuhiro Yasui, Yokohama-shi (JP); Toru Den, Tokyo (JP)

(72) Inventors: Yoshihiro Ohashi, Tokyo (JP); Nobuhiro Yasui, Yokohama-shi (JP); Toru Den, Tokyo (JP)

(73) Assignee: CANON KABUSHIKI KAISHA, Tokyo (JP)

(21) Appl. No.: 14/118,462

(22) PCT Filed: Jul. 24, 2012
(86) PCT No.: PCT/JP2012/069277

§ 371 Date: Nov. 18, 2013

(30) Foreign Application Priority Data
Jul. 26, 2011 (JP) 2011-163109

(51) Int. Cl. G01T 1/20

(52) U.S. Cl. CPC G01T 1/2002; G01T 1/2006
USPC 250/361 R; 428/119; 428/212

(57) ABSTRACT

Provided is a scintillator having a function of waveguiding scintillation light to a photodetector and having a structure for increasing an amount of absorption of radiation. The scintillator has a first surface and a second surface which are not located on a same surface, and includes: a first phase; and a second phase having a refractive index higher than that of the first phase and having a linear attenuation coefficient different from that of the first phase, in which one of the first phase and the second phase includes multiple columnar portions arranged in a direction from the first surface to the second surface, and the multiple columnar portions are stacked in a state in which end faces of the columnar portions are partly offset with respect to each other in a direction parallel to the first surface or the second surface.

### TECHNICAL FIELD

The present invention relates to a scintillator which emits light when radiation is applied thereto. More particularly, the present invention relates to a scintillator having a function of waveguiding emitted light to a photodetector and having structure for increasing an amount of absorption of radiation. The present invention also relates to a radiation detector using the scintillator.

### BACKGROUND ART

In an X-ray computed tomography (CT) scanner or an X-ray flat panel detector (FPD) used in clinical practice or the like, an X-ray which passes through an object is received by a scintillator, and light emitted from the scintillator is detected by a photodetector. In this case, in order to minimize the amount of radiation applied to the object and in order to reduce damage to the photodetector, it is desirable that the X-ray which enters the scintillator be totally absorbed by the scintillator and converted into light. In order to absorb the X-ray, the scintillator is required to have a thickness corresponding to the energy of incident X-ray. Therefore, in order to suppress lowering of the spatial resolution, the scintillator is required to have a structure which suppresses diffusion of light. For example, in Patent Literature 1, the diffusion of light is suppressed by embedding, in a matrix material, light absorbing or light reflecting fibers placed so as to be substantially parallel to one another. In Patent Literature 1, when the linear attenuation coefficient of the fibers is low and the X-ray stopping power of the fibers is low, if the fibers are placed along the direction of incidence of the X-ray, the X-ray penetrates the matrix material, and thus, by placing the fibers at an angle of 0 to 45 degrees, more generally, 5 to 15 degrees with respect to an upper surface of the matrix material, the power of stopping an X-ray which vertically enters the upper surface of the matrix material is improved. Further, Patent Literature 2 discloses a scintillation plate having high emission efficiency without impairment of resolution. The scintillation plate has a plate-like substrate and multiple through holes in a thickness direction of the substrate, in which the cross-sectional area in a direction perpendicular to the direction of the penetration of the through holes is different between one surface side and the other surface side of the substrate, and a scintillation material is filled into the through holes.

### CITATION LIST

### Patent Literature

PTL 1: Japanese Patent Application Laid-Open No. 2001-058881 (corresponding version: U.S. Pat. No. 6,391,434)
PTL 2: Japanese Patent Application Laid-Open No. 2005-9872

### SUMMARY OF INVENTION

### Technical Problem

However, the above-mentioned conventional structure in which the fibers placed parallel to one another are tilted is effective only when the incident X-ray is parallel light. Specifically, when an X-ray which is emitted from a point source and spread radially is used, the incident angle of the X-ray on the upper surface of the scintillator differs depending on the location, and thus, the angle formed with respect to the direction of the fibers varies, which results in variations in the stopping power. In a typical X-ray FPD, the incident angle of X-ray differs between a center region and a peripheral region of the FPD by 10 degrees or more, and penetration of the X-ray occurs in a region in which the direction of the fibers coincides with the direction of incidence of the X-ray. In this way, the conventional structure in which the fibers are tilted has a problem that uniform stopping power is not exhibited with regard to an X-ray emitted from a point source and penetration of an X-ray occurs in a region in which the direction of the fibers coincides with the direction of incidence of the X-ray.

The present invention has been accomplished in view of the above-mentioned background art, and an object of the present invention is to provide a scintillator having a function of waveguiding scintillation light to a photodetector and having a structure for increasing the amount of absorption of radiation, and a radiation detector using the scintillator.

### Solution to Problem

The above-mentioned problem can be solved by the following constitution of the present invention.

That is, according to an aspect of the present invention, there is provided a scintillator having a first surface and a second surface which are not located on a same surface, the scintillator including:

a first phase; and
a second phase having a refractive index higher than a refractive index of the first phase and having a linear attenuation coefficient different from a linear attenuation coefficient of the first phase,
in which one of the first phase and the second phase includes multiple columnar portions arranged in a direction from the first surface to the second surface, and the multiple columnar portions are stacked in a state in which end faces of the multiple columnar portions are partly offset with respect to each other in a direction parallel to one of the first surface and the second surface.

Further features and aspects of the present invention will become apparent from the following detailed description of exemplary embodiments with reference to the attached drawings.

### Advantageous Effects of Invention

According to the present invention, it is possible to provide a scintillator having the function of waveguiding emitted light to a photodetector and having a structure for increasing the amount of absorption of radiation.

Further features of the present invention will become apparent from the following description of exemplary embodiments with reference to the attached drawings.

### BRIEF DESCRIPTION OF DRAWINGS

FIGS. 1A and 1B are schematic views illustrating a scintillator according to a first embodiment of the present invention.

FIG. 2 is a schematic view illustrating a state of radiation leakage.

FIG. 3 is a schematic view illustrating a scintillator according to a second embodiment of the present invention.

FIGS. 4A and 4B are schematic views illustrating a scintillator according to a third embodiment of the present invention.

FIG. 5 is a schematic view illustrating a scintillator according to a fourth embodiment of the present invention.

FIG. 6 is a schematic view illustrating a scintillator according to a fifth embodiment of the present invention.

FIGS. 7A and 7B are X-ray microscope photographs of the scintillator manufactured in a first example of the present invention and in a comparative example, respectively.

FIGS. 8A and 8B are graphs showing emitted light propagation properties of the scintillator manufactured in the first example of the present invention and in the comparative example, respectively.

FIG. 9 is a schematic view of a radiation detector according to the present invention.

### DESCRIPTION OF EMBODIMENTS

Scintillators according to embodiments of the present invention are described in detail in the following.

Note that, there are various embodiments for carrying out the present invention (various structures and various materials), but a point common to the various embodiments is that the scintillator has a first surface and a second surface which are not located on a same surface, and has a first phase and a second phase whose refractive index is higher than that of the first phase and whose linear attenuation coefficient is different from that of the first phase, and that one of the first phase and the second phase includes multiple columnar portions arranged in a direction from the first surface to the second surface, and the multiple columnar portions are stacked in a state in which end faces thereof are partly offset with respect to each other in a direction parallel to the first surface or the second surface. Therefore, when light in a higher refractive index phase is totally reflected by a lower refractive index phase located around the higher refractive index phase and is waveguided to travel in the higher refractive index phase, at least part of radiation which is incident from an arbitrary direction is intercepted by a phase with a higher linear attenuation coefficient. In other words, it can be said that light generated in the scintillator travels toward a first principal surface or a second principal surface in a state in which the light is confined in the higher refractive index phase (that is, without diffusion of the light). In this way, in the various embodiments of the present invention, the scintillator itself has a waveguiding function (light guiding function). In this connection, as illustrated in FIG. 9, for example, it is to be noted that a first principal surface 91 is a surface which faces photodetectors 94 and a second principal surface 92 is a surface which radiation such as an X-ray enters. This enables waveguiding (light guiding) of light generated in a scintillator 95 toward the photodetectors 94, and a scintillator having excellent light utilization efficiency can be provided, and a radiation detector using the scintillator having high luminance and high resolution can be provided.

Note that, in the embodiments described below, the other crystal phase as the higher refractive index phase has a part exposed on the first principal surface and a part exposed on the second principal surface, but it is preferred to have a structure in which the one crystal phase as the lower refractive index phase also has a part exposed on the first principal surface and a part exposed on the second principal surface and the exposed parts are connected to each other. This enables waveguiding (light guiding) of light in the other crystal phase as the higher refractive index phase to the first principal surface or the second principal surface to be achieved more reliably without diffusion of the light.

Further, it is preferred to have a structure in which the one crystal phase as the lower refractive index phase is located within the other crystal phase as the higher refractive index phase. This can suppress the ratio of a part occupied by the one crystal phase as the lower refractive index phase in the scintillator, and still, a sufficient waveguiding function (light guiding function) can be obtained.

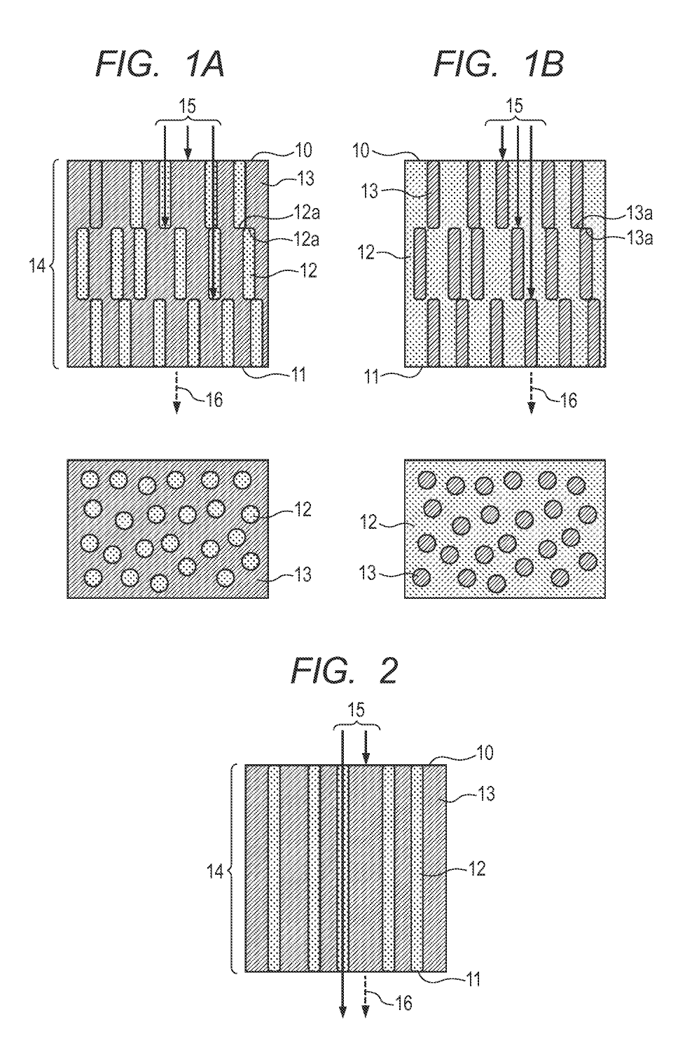

A first embodiment of the present invention is described in the following with reference to FIGS. 1A and 1B. Upper parts of FIGS. 1A and 1B are schematic views each showing a section perpendicular to a first principal surface 10 or a second principal surface 11 of a scintillator 14 according to the first embodiment, while lower parts of FIGS. 1A and 1B are schematic views each showing a section parallel to the first principal surface 10 or the second principal surface 11 of the scintillator 14 according to the first embodiment. FIG. 1A illustrates a structure in which a second phase 13 surrounds a first phase 12, while FIG. 1B illustrates a structure in which the first phase 12 surrounds the second phase 13. The term “linear attenuation coefficient (μ)” herein employed is defined as μ(cm⁻¹) satisfying the relationship of I/I0=exp(−μt), where I0 is the number of photons in X-rays which enter a substance, I is the number of photons in the X-rays which transmit the substance, and t(cm) is the thickness of the substance.

As illustrated in FIGS. 1A and 1B, the present embodiment relates to the scintillator 14 having the first principal surface 10 and the second principal surface 11 which are not located on a same surface, and having the first phase 12 and the second phase 13 whose refractive index is higher than that of the first phase 12 and whose linear attenuation coefficient is different from that of the first phase 12. Multiple columnar portions are arranged in any one of the first phase 12 and the second phase 13 in a direction from the first principal surface 10 to the second principal surface 11, and the multiple columnar portions are stacked in a state in which end faces thereof (12a or 13a) are partly offset with respect to each other in a direction parallel to the first principal surface 10 or the second principal surface 11. In the scintillator 14, a part of the first phase 12 is exposed on the first principal surface 10 and a part of the first phase 12 is exposed on the second principal surface 11, and a part of the second phase 13 is exposed on the first principal surface 10 and a part of the second phase 13 is exposed on the second principal surface 11. One of the first phase 12 and the second phase 13 having a lower linear attenuation coefficient is shaped so that at least part of radiation which is incident on the lower linear attenuation coefficient phase in an arbitrary direction from the first principal surface 10 is intercepted by the higher linear attenuation coefficient phase. With such a structure, a scintillator which has the function of waveguiding emitted light to a photodetector and has structure for increasing the amount of absorption of radiation can be provided.

A specific case is now described in detail with reference to FIG. 1A in which the refractive index of the second phase 13 is higher than that of the first phase 12 and the linear attenuation coefficient of the second phase 13 is higher than that of the first phase 12. The linear attenuation coefficient of the second phase 13 is two orders of magnitude or more higher than that of the first phase 12, and the combination is such that scintillation light 16 generated from the scintillator 14 when radiation 15 is applied thereto mainly comes from the second phase 13. In this case, the refractive index of the second phase 13 is higher than that of the first phase 12, and thus, among the scintillation light 16 generated from the second phase 13, light which is incident on an interface with the first phase 12 at a total reflection critical angle or larger is totally reflected. Accordingly, the scintillation light 16 generated from the second phase 13 travels while being repeatedly refracted and reflected, and propagates in a state in which diffusion of the light is suppressed, and, as a result, the spatial resolution is improved. However, when the direction of incidence of the radiation 15 coincides with the longitudinal direction of the first phase 12 having a lower linear attenuation coefficient, the radiation 15 is hardly intercepted and passes through the scintillator 14. Therefore, in the structure as illustrated in FIG. 2 in which the first phase 12 penetrates from the first principal surface 10 to the second principal surface 11 with a constant diameter, the radiation 15 passes through the second principal surface 11. This radiation leakage is not preferred from the viewpoint of fully utilizing the applied radiation as signals and minimizing the amount of radiation applied to the object, and also from the viewpoint of reducing damage to the photodetector.

In this case, light converted into the scintillation light 16 by the first phase 12 whose refractive index is lower than that of the second phase 13 does not, according to simple geometrical optics, have a component which is reflected at an interface with the second phase 13, and thus, diffuses in the scintillator 14. This light cannot be therefore used as a signal from the viewpoint of high resolution imaging. This means that part of the applied radiation which is absorbed by the first phase 12 is lost. In order to acquire the same level of X-ray image, a certain amount of radiation is necessary, which results in the necessity of increasing the amount of radiation applied to the object. In other words, when the first phase 12 absorbs a significant amount of the radiation 15 as compared with the second phase 13, there is an effect of reducing damage to the photodetector, but there is no effect of minimizing the amount of radiation applied to the object. In conclusion, it is desirable that the first phase 12 absorbs substantially none of the radiation 15 as compared with the second phase 13 and only plays a role in forming an interface by which the scintillation light 16 generated from the second phase 13 is reflected.

This embodiment relates to a scintillator having the second phase 13 shaped so that at least part of radiation which is incident from an arbitrary direction on the first principal surface 10 is intercepted by the second phase 13 whose linear attenuation coefficient is higher with respect to the shape of the first phase 12 whose linear attenuation coefficient is lower. Further, the shape of the first phase 12 whose linear attenuation coefficient is lower is such that the first phase 12 has central axes extending perpendicularly to the first principal surface 10 or the second principal surface 11, and the central axes are partly offset with respect to each other in a direction parallel to the first principal surface or the second principal surface. Specifically, as illustrated in FIG. 1A, the first phase 12 does not penetrate from the first principal surface 10 to the second principal surface 11, and the multiple columnar portions arranged in the first phase 12 in the direction from the first principal surface 10 to the second principal surface 11 (direction of incidence of the radiation 15) are stacked in a state where the end faces thereof (12a) are partly offset with respect to each other in the direction parallel to the first principal surface 10 or the second principal surface 11. Three or more layers of the multiple columnar portions may be stacked. The layers are denoted as the first layer, the second layer, . . . , and the n-th layer in the mentioned order from the side of incidence of the radiation, with the region in which the offset is generated being a boundary. With such a multilayer structure, a scintillator which has the function of waveguiding scintillation light and has a structure for increasing the amount of absorption of radiation can be provided. Specifically, among the radiation 15 which enters the first layer, most of radiation which passes through the first layer because the direction thereof coincides with the longitudinal direction of the first phase 12 is absorbed by the second phase 13 in the second layer to be converted into the scintillation light 16. Further, there is a possibility that a region of the first phase 12 in the first layer and a region of the first phase 12 in the second layer overlap each other, but radiation which leaks from such a region is absorbed in a subsequent lower layer to be converted into the scintillation light. As a result, the possibility that the radiation 15 is emitted from the second principal surface 11 in the end is reduced as much as possible. The radiation is absorbed by the second phase 13 in any one of the regions in the scintillator 14 to be converted into the scintillation light 16. The propagation characteristics of emitted light are hardly degraded by the structure having the offset as illustrated in FIG. 1A, and the structure as illustrated in FIG. 1A has resolution which is comparable to that of the structure without the offset as illustrated in FIG. 2.

The shape of the columnar portions is not limited to a cylinder such as illustrated in FIGS. 1A and 1B and may be various shapes, including a polygonal prism. Further, it is preferred that the diameter of the columnar portion be in the range of 300 nm or more and 30 μm or less. Specifically, generated light reaches the photodetector while being reflected by an interface between the first phase and the second phase. When the period of the structure is shorter than the wavelength of the light, much component of the light passes through the interface without being reflected.

Therefore, it is desirable that the diameter of the columnar portions be longer than the wavelength of the generated light.

In particular, a scintillator which emits light in the ultra-violet region of 300 nm or more is also within the scope of the present invention, and thus, it is desirable that the diameter of the columnar portion be 300 nm or more. Further, when the diameter of the columnar portion is larger than a pixel of the photodetector, the effect of confining light within a pixel is reduced, and thus, it is desirable that the upper limit of the diameter of the columnar portion be smaller than the size of a pixel. According to the present invention, in particular, a photodetector having a pixel size of 30 μm square is used, and thus, it is desirable that the diameter of the columnar portion be 30 μm or less.

Therefore, it is preferred that the diameter of the columnar portion be in the range of 300 nm or more and 30 μm or less. Here, when the shape of the columnar portion is not a cylinder but a polygonal prism, the diameter will be the diameter of a circumscribed circle. Further, the central axis of the columnar portion will be an axis which passes through the center of the circumscribed circle and extends in a direction perpendicular to the first principal surface or the second principal surface. As illustrated in FIGS. 1A and 1B, the columnar portions are stacked along the direction of incidence of the radiation so that the central axes thereof are partly offset with respect to each other in the direction parallel to the first principal surface or the second principal surface, and hence radiation which passes through the lower linear attenuation coefficient phase is intercepted by the higher linear attenuation coefficient phase. Thus, penetration of radiation can be prevented.

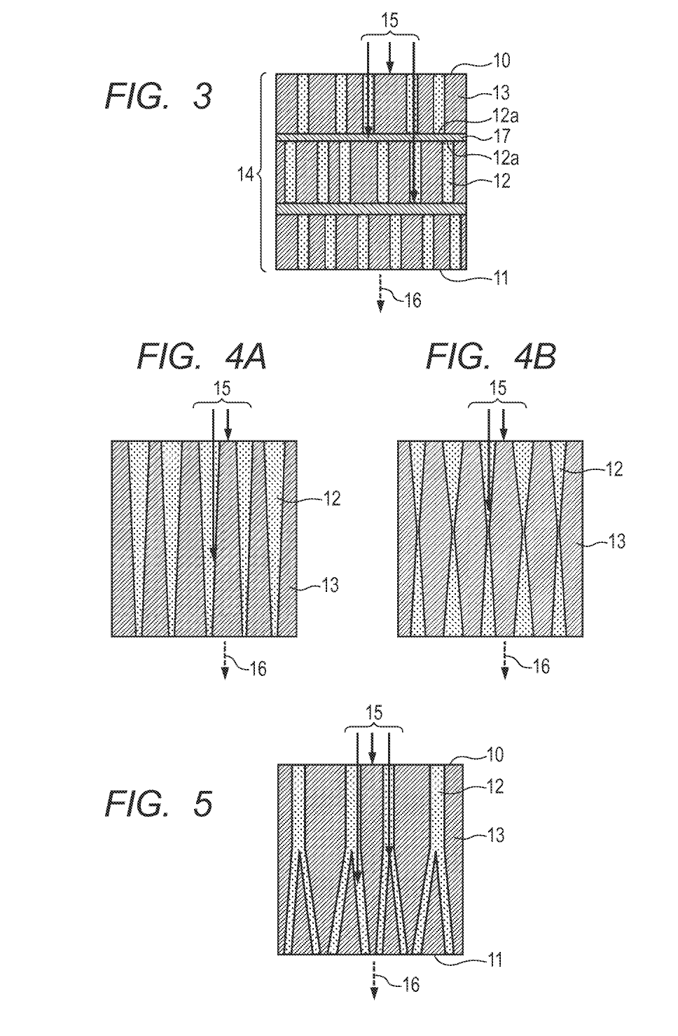

The length of the columnar portion in the direction of extension may be arbitrarily adjusted by controlling the positions at which offset between the end faces of the columnar portions is introduced. However, the scintillator according to the present invention has the structure in which radiation which passes through the lower linear attenuation coefficient phase is absorbed by the higher linear attenuation coefficient phase in multiple stages by introducing the offset between the end faces of the columnar portions, and, when the distance from an adjacent offset is larger than ⅔ of the film thickness, leaked radiation will have to be absorbed by the remaining ⅓ of the film thickness, and thus, the effect of intercepting the radiation cannot be sufficiently obtained. Therefore, it is desirable that the length of the columnar portion in the direction of extension be ⅔ or less of the film thickness. Further, when the distance from an adjacent offset is small, the effect of intercepting the radiation cannot be obtained, and thus, it is desirable that the length of the columnar portion in the direction of extension be 10 μm or more. In summary, it is preferred that the length of the columnar portion in the direction of extension be within the range of 10 μm or more and ⅔ or less of the film thickness. Further, another scintillator according to the present invention (a second embodiment), as illustrated in FIG. 3, an interlayer 17 may be provided in the scintillator 14 between end faces (12a) of columnar portions and end faces (12a) of other columnar portions arranged in the stack direction. Introduction of such an interlayer does not affect the resolution. Further, in order that light which propagates through the second phase 13 is not refracted or reflected on the introduced interlayer, it is desirable that the interlayer 17 be formed of the same material as that of the second phase 13.

Further, another scintillator according to the present invention (a third embodiment) is a scintillator in which, as illustrated in FIG. 4A, the first phase 12 whose linear attenuation coefficient is lower is in the shape of a cylinder extending in a direction of the normal to the first principal surface 10 or the second principal surface 11 so that the diameter of a section thereof in the direction parallel to the first principal surface 10 or the second principal surface 11 becomes smaller from the first principal surface toward the second principal surface. Among the scintillation light 16 generated from the second phase 13, light which is incident on an interface with the first phase 12 at a total reflection critical angle or larger is totally reflected. The scintillation light 16 generated from the second phase 13 travels while being repeatedly refracted and reflected, and propagates in a state in which diffusion of the light is suppressed, and, as a result, the spatial resolution is improved. In this case, the volume occupied by the first phase 12 becomes smaller toward the second principal surface 11, and thus, the extent of the diffusion of the scintillation light 16 is larger than in the case of the structure illustrated in FIG. 2, but radiation leakage is effectively prevented. Further, as illustrated in FIG. 4B, with regard to the shape of the first phase 12, the region in which the diameter of a section of the first phase in the direction parallel to the first principal surface 10 or the second principal surface 11 becomes the smallest from the first principal surface toward the second principal surface may be at an arbitrary position in the scintillator 14. In an example illustrated in FIG. 4B, the region having the smallest diameter is located substantially in the middle in the thickness direction of the scintillator 14. Further, there may be multiple nodes at which the diameter of a section becomes the smallest.

Further, another scintillator according to the present invention is a scintillator having a first principal surface and a second principal surface which are not located on a same surface, the scintillator including:

a first phase; and
a second phase having a refractive index higher than a refractive index of the first phase and having a linear attenuation coefficient different from a linear attenuation coefficient of the first phase,
wherein any one of the first phase and the second phase branches from the first principal surface side to the second principal surface side. As an embodiment of such a scintillator, FIG. 5 illustrates an exemplary structure in which the first phase 12 whose linear attenuation coefficient is lower than that of the second phase 13 branches midway (a fourth embodiment). With such structure, among the radiation 15 which enters the first principal surface 10, radiation which passes through the first phase 12 is absorbed by the second phase 13 in a branch region to be converted into the scintillation light 16. The possibility that the radiation 15 may pass through the scintillator 14 without interacting with the second phase 13 is reduced as much as possible, and as a result, the radiation 15 is absorbed by the second phase 13 in any one of the regions in the scintillator 14 to be converted into the scintillation light 16.

The scintillators according to various embodiments of the present invention described above can be formed in a phase separation structure including the above-mentioned multiple columnar portions. The phase separation structure according to various embodiments of the present invention can be formed by any method insofar as eutectic material systems with optimum composition can be melted and solidified so as to have unidirectionality. For example, eutectic material systems shown in Table 1 below which are combinations of alkali halide materials can be used, but the various embodiments of the present invention is not particularly limited thereto and a phase separation structure to be the scintillator according to the present invention can be obtained also in other eutectic systems including oxide materials.

TABLE 1

| | | | | | Ratio of Lower |
|---|---|---|---|---|---|
| | | | | | Refractive Index |
| | Eutectic | Eutectic | Refractive | Refractive | Phase/Higher |
| First Phase:Second | Composition | Temperature | Index of | Index of | Refractive Index |
| Phase | (mol %) | (° C.) | First Phase | Second Phase | Phase |
| NaBr:CsI | 40:60 | 432 | 1.64 | 1.80 | 0.911 |
| NaCl:CsI | 30:70 | 490 | 1.55 | 1.80 | 0.861 |
| NaF:CsI | 5:95 | 599 | 1.32 | 1.80 | 0.733 |
| KCl:CsI | 40:60 | 447 | 1.49 | 1.80 | 0.828 |
| CsI:NaI | 51:49 | 428 | 1.80 | 1.85 | 0.973 |
| RbI:NaI | 50:50 | 505 | 1.61 | 1.85 | 0.870 |
| NaCl:NaI | 40:60 | 573 | 1.55 | 1.85 | 0.838 |
| NaF:NaI | 18:82 | 596 | 1.32 | 1.85 | 0.714 |
| NaF:RbI | 6:94 | 606 | 1.32 | 1.61 | 0.820 |
| NaCl:RbI | 35:65 | 482 | 1.55 | 1.61 | 0.963 |
| RbI:NaBr | 53:47 | 448 | 1.61 | 1.64 | 0.982 |
| NaF:CsBr | 6:94 | 595 | 1.32 | 1.71 | 0.772 |
| NaCl:CsBr | 40:60 | 463 | 1.55 | 1.71 | 0.906 |
| NaBr:CsBr | 41:59 | 465 | 1.64 | 1.71 | 0.959 |
| NaF:RbBr | 10:90 | 630 | 1.32 | 1.53 | 0.863 |
| RbBr:NaCl | 54:46 | 501 | 1.53 | 1.55 | 0.987 |
| RbBr:NaBr | 55:45 | 497 | 1.53 | 1.64 | 0.933 |
| NaCl:CsCl | 35:65 | 486 | 1.55 | 1.65 | 0.939 |
| NaF:RbCl | 15:85 | 624 | 1.32 | 1.53 | 0.863 |
| RbCl:NaCl | 56:44 | 550 | 1.53 | 1.55 | 0.987 |

When the phase separation structure is manufactured by melting and solidification, the temperature gradient is required to be controlled so that the liquid-solid interface is flat. For example, by the following manufacturing method, the scintillator having the phase separation structure according to the various embodiments of the present invention can be obtained. In the Bridgman process, a sample material enclosed in a cylindrical quartz tube or the like is vertically placed. A heater or a sample is moved at a fixed rate, and thus the position of the solidification interface can be controlled. In this manner, a phase separation scintillator according to the various embodiments of the present invention can be manufactured. The scintillator may also be similarly manufactured by pulling upward a crystal from a molten liquid as in the Czochralski process. In this case, unlike the Bridgman process in which the sample is solidified in a container, the liquid-solid interface may be formed without being affected by the wall surface of the container, which may be regarded as more preferred. Further, the scintillator may also be manufactured by the floating zone process.

In this case, if the conditions including the temperature gradient and the growth rate are held constant, in the formed structure, any one of the phases has a predetermined diameter from the first principal surface to the second principal surface and there is no interlayer as illustrated in FIG. 2. The scintillator according to the various embodiments of the present invention having a modified structure may be obtained by changing the temperature gradient and the growth rate when the sample is manufactured. Specifically, with regard to the structures illustrated in FIGS. 1A and 1B, by changing the temperature when the sample is molten and solidified so as to have unidirectionality, the growth of the first phase pauses and then the growth restarts. In this way, the first layer and the second layer described above are obtained. By changing the temperature n times in an arbitrary region into which the modulation is to be introduced, a scintillator having the above-mentioned modulated structure including the first layer to the n-th layer is obtained. In this case, depending on the combination of the materials, by introducing the modulation, the structure in which the interlayer 17 is introduced, as illustrated in FIG. 3, may be obtained. The interlayer 17 is formed of the same material as that of the second phase 13. In the schematic views of FIGS. 1A, 1B, and 3, the first phase 12 has columnar structures which are perpendicular to the first principal surface 10 or the second principal surface 11, but the first phase 12 is not necessarily required to have the columnar structures. Specifically, when the growth of the first phase pauses and then the growth restarts, the structure may be so that, after the first phase 12 first spreads radially, the growth progresses in the direction perpendicular to the first principal surface 10 or the second principal surface 11. Such a structure can be obtained when phase separation is used in the manufacture.

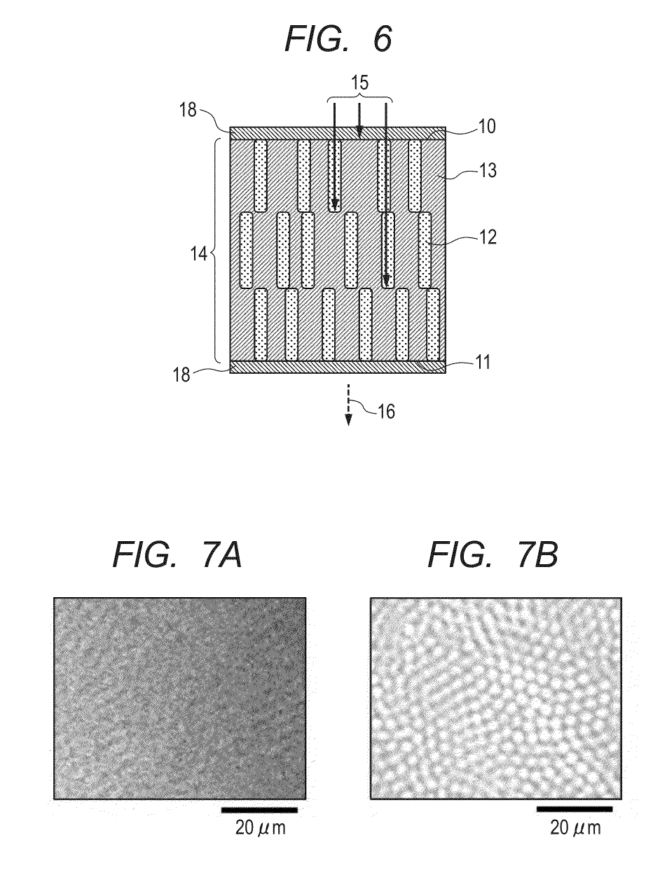

Further, as illustrated in FIG. 6, any one phase 18 of the first phase and the second phase may be provided on at least one of the first principal surface 10 and the second principal surface 11 of the scintillator 14 (a fifth embodiment).

By placing the photodetector and the second principal surface of the scintillator so as to face each other, the structure may be used as a radiation detector.

### EXAMPLES

Hereinafter, the present invention is described more concretely with examples. However, the present invention is not limited by the following examples.

### Example 1

The present example corresponds to FIG. 1A. An example of manufacturing a structure is described in detail in which sodium chloride (NaCl) is used as the first phase 12 and cesium iodide (CsI) is used as the second phase 13 and NaCl columnar structures are partly offset in a direction perpendicular to the penetration direction of X-rays. The phase diagram of CsI and NaCl is of an eutectic system. By melting a sample which contains 30 mol % of NaCl with respect to CsI and solidifying the sample so as to have unidirectionality, a phase separation structure in which columnar structures of NaCl are embedded in CsI is formed. In this case, the refractive index of CsI is 1.80 and the refractive index of NaCl is 1.55, and thus, among light generated on the CsI side, components which satisfy conditions for total reflection are reflected at an interface with NaCl. The linear attenuation coefficients of CsI and NaCl at 40 keV are 103.7 and 1.796 (cm⁻¹), respectively. In this way, the linear attenuation coefficient of NaCl is approximately 1/60 of that of CsI. When X-rays of 40 keV are incident along the NaCl columnar structures, almost none of the X-rays are absorbed and approximately 96% of the X-rays penetrates when the thickness is 400 μm. Therefore, in regions corresponding to the NaCl columnar structures, the X-rays penetrate so as to be spot-like. The present example has a multilayer structure in which central axes of the NaCl columnar structures are partly offset with respect to each other in the direction parallel to the first principal surface or the second principal surface in the scintillator. With this, X-rays which pass along the NaCl columnar structures are absorbed by CsI to be converted into scintillation light, and X-ray leakage is suppressed.

In manufacturing the sample, first, 0.10 mol % of thallium iodide (TlI) was added to a powder mixture including 30 mol % of NaCl with respect to CsI and mixing was carried out, and the sample was enclosed in a vacuum quartz tube. Then, the sample was introduced into a Bridgman furnace and the temperature was raised to 800° C. After the sample was entirely molten, the state was held for 30 minutes, and then, the temperature was held at 650° C. The sample was pulled down to carry out the solidification gradually from the bottom of the sample. Further, the sample was caused to enter a region of the furnace in which cooling water circulated when the sample was pulled down, and thus, the temperature difference from the molten portion was set to be 30° C./mm or larger. The pulling down was carried out at a rate of 100 μm/min. Temperature control was carried out every one minute. The pulling down was carried out under a state in which the temperature was instantaneously dropped by 10° C. in approximately 3 seconds. The sample manufactured in this way was cut at a thickness of 400 μm, and the structure thereof was observed under a scanning electron microscope (SEM). A structure in which NaCl columnar structures were embedded in CsI could be recognized. Observation of a surface perpendicular to the direction of solidification clarified that the diameter and the period of the NaCl columnar structures were 2 μm and 5 μm, respectively, and volumetric percentage of the NaCl columnar structures was 20%. The NaCl columnar structures were interrupted approximately every 100 μm deep in the direction parallel to the direction of solidification. According to evaluation in detail, an interlayer having a thickness of 5 μm was introduced three times in the scintillator having a thickness of 400 μm, and the structure was a four-layer structure having different periods. The thickness of the interlayers may be adjusted to some extent by changing the time during which the temperature was caused to drop, and a structure in which interlayers do not substantially exist corresponding to FIGS. 1A and 1B, and a structure into which interlayers are introduced corresponding to FIG. 3 may be obtained.

FIGS. 7A and 7B are X-ray microscope photographs when X-rays were applied to samples. FIGS. 7A and 7B qualitatively show X-ray leakage after the X-rays passed through the samples, and as a region becomes whiter, the amount of X-rays which penetrate the region is larger. FIG. 7A shows the sample of the present example having the four-layer structure having different periods into which the interlayers are introduced. FIG. 7B shows a sample for comparison having only one layer into which the interlayers are not introduced corresponding to FIG. 2. In FIG. 7B, X-rays which are incident along the NaCl columnar structures appear as white spots, and penetration of the X-rays is recognized. On the other hand, in FIG. 7A, there exists no region in which the incident X-rays may pass through the sample, and the X-rays are absorbed in any one of the regions, and thus, it is made clear that X-ray leakage in the shape of spots was suppressed. The amount of X-rays which passed through the samples was measured. In FIG. 7B, 20% of the incident X-rays penetrated, while, in FIG. 7A, the amount of penetration was suppressed to be 4%. The amount of leakage when the structure is solely formed of CsI at a thickness of 400 μm is 2%, and thus, it was recognized that, in the present example, the amount of absorbed X-rays was substantially comparable to the case in which the structure was solely formed of CsI.

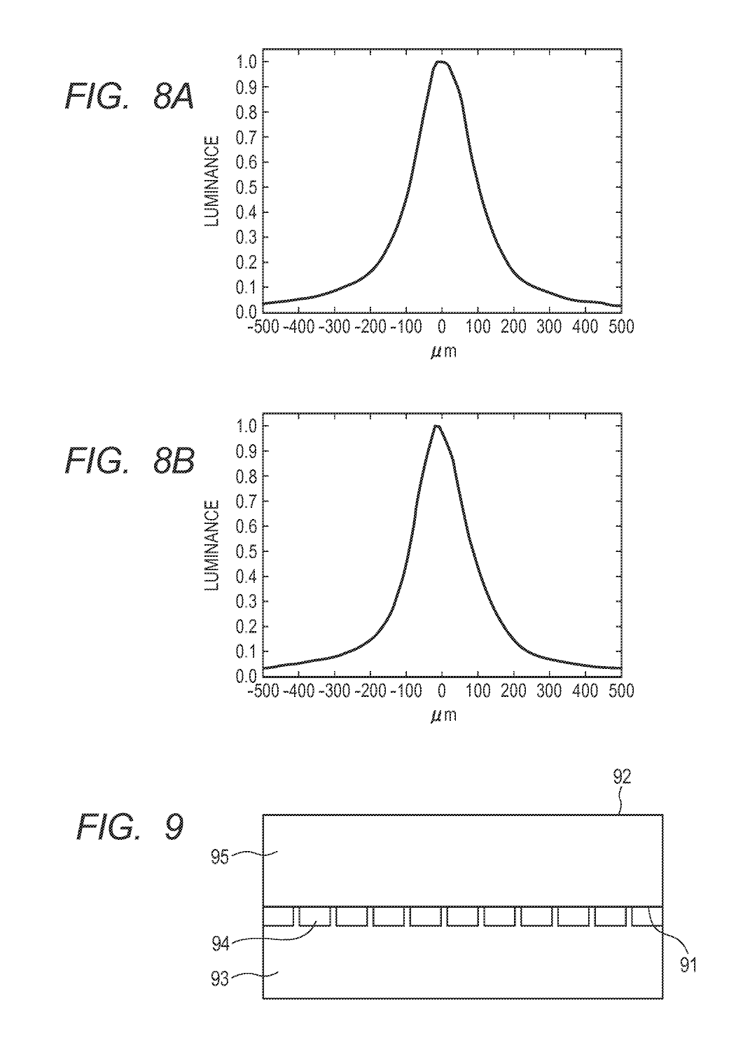

In order to evaluate the spatial resolution, X-rays obtained using a tungsten light bulb as the source of X-rays under the conditions of 80 kV and 1 mA were applied to the samples through an opening of φ100 μm in a tungsten plate having a thickness of 2 mm, and the light intensity distribution at the bottom surface of the samples was measured. The measurement was made using CCDs with 50 μm pitches. FIG. 8A shows an intensity profile of a section passing through a peak value of the distribution. For comparison, FIG. 8B shows an intensity profile of a sample manufactured without introducing the interlayers thereinto corresponding to the structure illustrated in FIG. 2. The half-width with regard to the peak luminance was calculated. In the case illustrated in FIG. 8A, the half-width was 194 μm. In the case illustrated in FIG. 8B, the half-width was 190 μm. This means that the extent of degradation in propagation characteristics of the scintillation light due to introduction of the interlayers is small, and that the extent of diffusion of light in waveguiding is small in the sample of the present example and the light is effectively waveguided to the radiation receiving surface.

The scintillator according to the present example functions as a radiation detector when combined with a photodetector. Specifically, by placing the manufactured scintillator on a photodetector in which light detection pixels are two-dimensionally arranged in an array so that the second principal surface thereof faces the photodetector, the radiation detector may be formed.

As described above, by allowing the columnar structures to be partly offset with respect to each other in the direction perpendicular to the penetration direction of the X-rays as in the present example, a scintillator may be obtained in which the amount of X-rays which pass through a sample is suppressed and diffusion of the scintillation light is suppressed.

As described above, it was confirmed that a scintillator according to the present example having the function of waveguiding, to a photodetector, scintillation light generated when radiation is applied thereto and having structure for increasing the amount of absorption of radiation could be obtained.

### Example 2

The present example corresponds to the embodiment shown in FIG. 1B. An example of manufacturing a structure is described in detail in which rubidium iodide (RbI) is used as the first phase 12 and sodium iodide (NaI) is used as the second phase 13 and NaI columnar structures are partly offset with respect to each other in a direction perpendicular to the penetration direction of X-rays. The phase diagram of RbI and NaI is of an eutectic system. By melting a sample which contains 50 mol % of NaI with respect to RbI and solidifying the sample so as to have unidirectionality, a phase separation structure in which columnar structures of NaI are embedded in RbI is formed. In this case, the refractive index of RbI is 1.61 and the refractive index of NaI is 1.85, and thus, among light generated on the NaI side, components which satisfy conditions for total reflection are reflected at an interface with RbI. In this case, X-rays of 40 keV are used. The linear attenuation coefficients of RbI and NaI at 40 keV are 60.00 and 68.94 (cm⁻¹), respectively. In this way, the linear attenuation coefficient of RbI is lower than that of NaI approximately by 15%, and thus, when X-rays at 40 keV are incident along a RbI matrix structure, the absorptance is lower than that when X-rays enter the NaI columnar structures. Therefore, the amount of penetration of the X-rays is larger in a region corresponding to the RbI matrix structure. The present example has a multilayer structure in which central axes of the NaI columnar structures are partly offset with respect to each other in the direction parallel to the first principal surface or the second principal surface in the scintillator. With this, X-rays which pass along the RbI matrix structure are absorbed by NaI to be converted into scintillation light, and X-ray leakage is suppressed.

In manufacturing the sample, 0.10 mol % of thallium iodide (TlI) was added to a powder mixture including 50 mol % of RbI with respect to NaI and mixing was carried out, and the sample was enclosed in a vacuum quartz tube. Then, the sample was introduced into a Bridgman furnace and the temperature was raised to 800° C. After the sample was entirely molten, the state was held for 30 minutes, and then, the temperature was held at 665° C. The sample was pulled down to carry out the solidification gradually from the bottom of the sample. Further, the sample was caused to enter a region of the furnace in which cooling water circulated when the sample was pulled down, and thus, the temperature difference from the molten portion was set to be 30° C./mm or larger. The pulling down was carried out at a rate of 100 μm/min. Temperature control was carried out every one minute. The pulling down was carried out under a state in which the temperature was instantaneously dropped by 10° C. in approximately 3 seconds. The sample manufactured in this way was cut at a thickness of 400 μm, and the structure thereof was observed with a scanning electron microscope (SEM). A structure in which NaI columnar structures were embedded in RbI could be recognized. The NaI columnar structures were interrupted approximately every 100 μm deep in the direction parallel to the direction of solidification. Further, by a similar method to that in the case of Example 1, a structure into which an interlayer is introduced may also be obtained.

As described above, it was confirmed that a scintillator according to the present example having the function of waveguiding, to a photodetector, scintillation light generated when radiation is applied thereto and having structure for increasing the amount of absorption of radiation could be obtained.

### Example 3

In the present example, an example of manufacturing a scintillator is described in detail with reference to FIGS. 4A and 4B, in which NaCl is used as the first phase 12 and CsI is used as the second phase 13, and the NaCl portions are in the shape of a cylinder extending in the direction of the normal to the first principal surface 10 or the second principal surface 11 so that the diameter of a section thereof in the direction parallel to the first principal surface 10 or the second principal surface 11 becomes smaller from the first principal surface toward the second principal surface.

A sample was manufactured by pulling down the sample in a method similar to that of Example 1. The pulling down was carried out at a rate of 100 μm/min at the beginning, and the rate was gradually increased so as to be increased by 100 μm/min per minute, and the rate finally reached 400 μm/min. The sample manufactured in this way was cut at a thickness of 400 μm, and the structure thereof was observed with a scanning electron microscope (SEM). A structure in which NaCl columnar structures were embedded in CsI could be recognized. Observation of a surface perpendicular to the direction of solidification clarified that the diameter and the period of the NaCl columnar structures on the first principal surface 10 side were 2 μm and 4 μm, respectively, and that the diameter and the period of the NaCl columnar structures on the second principal surface 11 side were 1 μm and 2 μm, respectively. As illustrated in FIG. 4A, in the structure, the diameter and the period gradually changed from the first principal surface to the second principal surface. With such a structure, the volume occupied by NaCl portions having a lower linear attenuation coefficient becomes smaller toward the second principal surface 11, and thus, compared with the case of the structure illustrated in FIG. 2, radiation leakage is suppressed. The obtained sample was cut at a thickness of 400 μm, and the spatial resolution was evaluated in a way similar to that of Example 1. The half-width with regard to the peak luminance was 200 μm. This means that the extent of diffusion of light in waveguiding is small in the sample of the present example and the light is effectively waveguided to the radiation receiving surface.

Further, as illustrated in FIG. 4B, with regard to the shape of the NaCl structures, the region in which the diameter of a section thereof in the direction parallel to the first principal surface 10 or the second principal surface 11 becomes the smallest from the first principal surface toward the second principal surface may be at an arbitrary location in the scintillator 14. Further, there may be multiple nodes at which the diameter of a section becomes the smallest. Such a structure may be obtained by modulating the pulling down rate. Specifically, the diameter and the period of the NaCl columnar structures may become smaller as the pulling down rate becomes higher, and the sizes are approximately inversely proportional to the square root of the pulling down rate. For example, by changing the pulling down rate from 100 μm/min to 400 μm/min, and then again to 100 μm/min, the structure having nodes as illustrated in FIG. 4B may be obtained. In this way, by modulating the pulling down rate multiple times, a structure having multiple nodes at which the diameter of a section becomes the smallest may be obtained. Further, the diameter and the period of the NaCl columnar structures may also be controlled by changing the temperature of the molten liquid. In this case, the diameter and the period become larger as the temperature of the molten liquid becomes lower. The temperature of the molten liquid depends on the design of the apparatus in which the pulling down is carried out, the size of the quartz tube in which the material is enclosed, and the like, and is appropriately set accordingly.

As described above, it was confirmed that a scintillator according to the present example having the function of waveguiding, to a photodetector, scintillation light generated when radiation is applied thereto and having structure for increasing the amount of absorption of radiation could be obtained.

### Example 4

In the present example, an example of manufacturing a scintillator is described in detail with reference to FIG. 5, in which NaCl is used as the first phase 12 and CsI is used as the second phase 13, and the NaCl portions branch or become integrated from the first principal surface 10 toward the second principal surface 11.

A sample was manufactured by pulling down the sample in a method similar to that of Example 1. The pulling down was carried out at a rate of 100 μm/min at the beginning, and, after the rate was held for some time, the pulling down rate was increased to 1,600 μm/min in one minute. The sample manufactured in this way was cut at a thickness of 400 μm so as to include a region where the pulling down rate was changed, and the structure thereof was observed with a scanning electron microscope (SEM). A structure in which NaCl columnar structures were embedded in CsI could be recognized. Observation of a surface perpendicular to the direction of solidification clarified that the diameter and the period of the NaCl columnar structures on the first principal surface 10 side were 2 μm and 4 μm, respectively. One NaCl columnar structure branched into approximately two to four NaCl columnar structures with a location at which the pulling down rate was changed being a border. The diameter and the period on the second principal surface 11 side on average were 500 nm and 1 μm, respectively. With such a structure, among radiation which enters the first principal surface, radiation which passes through the NaCl is absorbed by CsI in a branch region to be converted into the scintillation light. With such a branched structure, the possibility that the radiation may pass through the scintillator to leak without interacting with CsI is reduced as much as possible. As a result, the incident radiation is absorbed by CsI in any one of the regions in the scintillator to be converted into scintillation light.

The spatial resolution of the obtained sample was evaluated in a way similar to that of Example 1. The half-width with regard to the peak luminance was 195 μm. This means that the extent of diffusion of light in waveguiding is small in the sample of the present example and the light is effectively waveguided to the radiation receiving surface.

As described above, it was confirmed that a scintillator according to the present example having the function of waveguiding, to a photodetector, scintillation light generated when radiation is applied thereto and having structure for increasing the amount of absorption of radiation could be obtained.

### Example 5

In the present example, as exemplarily illustrated in FIG. 6, in the scintillator manufactured in Example 1 to Example 4 described above, any one phase of the first phase and the second phase is provided on at least one of the first principal surface and the second principal surface. It is desired that the phase provided in this case be formed of the same material as that of the second phase in order that light propagating through the second phase whose refractive index is higher is not refracted or reflected to diffuse. Here, a case in which a CsI phase is provided on the first principal surface side or on the second principal surface side is described.

First, in a scintillation structure manufactured in Example 1 to Example 4 in which NaCl was used as the first phase 12 and CsI was used as the second phase 13, a CsI phase was formed on the first principal surface by vapor deposition. First, the scintillation structure was set on a substrate holder in a vapor deposition apparatus to be a film formation region. As a vapor deposition source, CsI was filled into a resistive heating crucible having a diameter of 20 mm, and the distance between the vapor deposition source and the film formation region was 100 mm. Then, after the vapor deposition apparatus was once evacuated to the order of 10⁻⁴ Pa, the film formation region was heated to and held at 200° C. while being rotated at 5 rpm. The resistive heating crucible was heated to 700° C. and vapor deposition of CsI was carried out for 5 minutes, and the vapor deposition was completed. The structure was observed with a scanning electron microscope (SEM). It was recognized that a uniform CsI film was formed at a thickness of 5 μm. In this case, by varying the time period of the vapor deposition, the film thickness may be arbitrarily adjusted. Similarly, CsI may be formed on the second principal surface.

In order to evaluate the spatial resolution of the obtained sample, the half-width with regard to the peak luminance was calculated. The half-width was 195 μm. This means that the extent of diffusion of light in waveguiding is small in the sample of the present example and the light is effectively waveguided to the radiation receiving surface.

In this way, it was confirmed that, with regard to the scintillation structure according to the present example, a scintillator in which any one phase of the first phase and the second phase was provided on at least one of the first principal surface and the second principal surface could be obtained.

### INDUSTRIAL APPLICABILITY

The scintillator according to the present invention may be, when combined with a photodetector, used as a radiation detector which has the function of waveguiding emitted light to the photodetector and which suppresses radiation leakage. In particular, the scintillator may be used in a measurement apparatus for medical care, for industrial use, for high-energy physics, and for space use using radiation such as X-rays.

### REFERENCE SIGNS LIST

10 first principal surface
11 second principal surface
12 first phase
12a end face of columnar portion of first phase
13 second phase
13a end face of columnar portion of second phase
14 scintillator
15 radiation
16 scintillation light
17 interlayer
18 first phase or second phase
91 first principal surface
92 second principal surface
93 substrate
94 photodetector
95 scintillator crystal

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-163109, filed Jul. 26, 2011, which is hereby incorporated by reference herein in its entirety.

1. A scintillator having a first surface and a second surface which are not located on a same surface, the scintillator comprising:
a first phase; and
a second phase having a refractive index higher than a refractive index of the first phase and having a linear attenuation coefficient different from a linear attenuation coefficient of the first phase,
wherein one of the first phase and the second phase comprises multiple columnar portions arranged in a direction from the first surface to the second surface, and the multiple columnar portions are stacked in a state in which end faces of the columnar portions are partly offset with respect to each other in a direction parallel to the first surface or the second surface.

2. The scintillator according to claim 1, further comprising an interlayer provided between an end face of a columnar portion and an end face of another columnar portion arranged in the stack direction.

3. The scintillator according to claim 2, wherein the interlayer comprises the second phase.

4. The scintillator according to claim 1, wherein the one of the first phase and the second phase comprising the multiple columnar portions is a phase having a lower linear attenuation coefficient.

5. The scintillator according to claim 1, wherein the columnar portions are formed in a phase separation structure.

6. The scintillator according to claim 1, wherein the multiple columnar portions are stacked in the state in which the end faces thereof are partly offset with respect to each other in the direction parallel to the first surface or the second surface so that at least part of radiation which is incident from an arbitrary direction is intercepted by a phase having a higher linear attenuation coefficient.

7. The scintillator according to claim 1, wherein a diameter of the columnar portion is 300 nm or more and 30 μm or less.

8. The scintillator according to claim 1, wherein a length of the columnar portion in an extension direction is 10 μm or more and ⅔ or less of a film thickness.

9. The scintillator according to claim 1, wherein three or more layers of the multiple columnar portions are stacked.

10. A scintillator having a first surface and a second surface which are not located on a same surface, the scintillator comprising:
a first phase; and
a second phase having a refractive index higher than a refractive index of the first phase and having a linear attenuation coefficient different from a linear attenuation coefficient of the first phase,
wherein any one of the first phase and the second phase branches from the first surface side to the second surface side.

11. A radiation detector, comprising:
the scintillator according to claim 1; and
a photodetector disposed so as to face the scintillator,
wherein the second surface of the scintillator is disposed so as to face the photodetector.
